(19) United States
(12) Patent Application Publication
(10) Pub. No.: US 2005/0193104 A1
(43) Pub. Date: Sep. 1, 2005

(54) User interface for remote computing devices

(75) Inventors: Ryan Mason, San Jose, CA (US); Oleg Rombakh, Santa Clara, CA (US); Mark McKinney, San Jose, CA (US)

Correspondence Address: MCDERMOTT WILL & EMERY LLP, 18191 VON KARMAN AVE., IRVINE, CA, 92612-7107, US

(73) Assignee: Wyse Technology Inc.

(21) Appl. No.: 10/787,226

(22) Filed: Feb. 27, 2004

(51) Int. Cl. G06F 15/173

(52) U.S. Cl. 709/223

(57) ABSTRACT

An improved user interface for managing a connection between a local computing device and a remote computing device in which an improved user interface is displayed, and at least a first connection icon is displayed on the user interface, where the first connection icon represents a first connection between the remote computing device and a first local computing device. A user selection is input, where if the user selection includes the first connection icon, the first connection represented by the first connection icon becomes modifiable to alter the first connection. If the user selection includes an active area of the improved user interface, a second connection icon is displayed, where the second connection icon represents a second connection different than the first connection, between the remote computing device and a second local computing device.

### FIELD OF THE INVENTION

The present invention relates generally to the field of computer networking and, more particularly, relates to the management of a connection between a remote computing device and a local computing device using an improved user interface.

### DESCRIPTION OF THE RELATED ART

With regard to the design and implementation of computer networks, client/server applications can be developed in one of two ways. For instance, client-side applications can be large, requiring robust computers and operating systems to perform the bulk of the data processing at the desktop. Utilizing the Microsoft® Windows® operating systems and Intel® processors, most casual personal computer (“PC”) users have at least passing familiarity with these systems, known euphemistically as “fat” clients. Network designers, however, often disfavor using this type of device in a large network due to a high total cost of ownership (“TCO”), and redundant processing capabilities.

Alternatively, the client application and client device can be designed so that the majority of data processing occurs at a local computing device, such as a centralized server. These client devices, referred to as “thin” clients, are designed under the premise that most users connected to a powerful server via a network do not need the processing power of a fat client. With thin clients, the TCO is minimized, because the devices are less expensive to purchase than fat clients, and because thin clients can be centrally administered and updated from the server.

1) Management of connections from a desktop shell: The original desktop shell for the Microsoft® Windows® family of operating systems, known as Microsoft® Explorer, does not allow a user to add, edit or delete connections between a remote computing device and a local computing device from the desktop shell. For instance, users of applications such as Citrix®, which operates on the Microsoft® Windows® CE operating system, must use a specialized connection manager interface to administer each connection, and existing connections cannot be displayed on the desktop. Since the desktop is the primary interface between the operating system and the user, the user must currently make additional burdensome steps in order to view or edit their connections.

2) Display of published applications on the desktop shell: When a user logs on to a local computing device from a thin client, the local computing device authorizes the user to access and execute applications stored on the local computing device. These applications are known as “published applications.” Presently, the Microsoft® Windows® Explorer desktop shell does not allow a user to display published applications on the desktop, although applications stored on the remote computing device are displayed on the desktop shell. Again, this unnecessary distinction requires a user to take additional burdensome steps in order to access published applications

3) Processing of “hotkeys”: Operating systems such as the Microsoft® Windows® family of operating systems often include keyboard combinations known as “hotkeys,” which are keyboard shortcuts to cursor or mouse movements. One popular hotkey, for example, is the ALT-TAB hotkey, which allows a user to easily switch between multiple executing applications, instead of clicking on controls on the user interface with a mouse. If both the local computing device and the remote computing device are running similar operating systems, a user of the remote computing device may wish to use a hotkey on an application executing at the local computing device. If the hotkey is pressed, however, the remote computing device will “intercept” the hotkey, and execute the hotkey function instead of sending the hotkey through the connection. Since the user may not be aware that the application is being executed on a different computing device, hotkey processing can be confusing or illogical on conventional user interfaces.

4) Establishment of connection priority: Operating systems such as the Microsoft® Windows® family of operating systems conveniently allow users to sort icons by properties such as name, date, type and size. Users of remote computing devices, however, may wish to connect to local computing devices in a so-called “failover order,” such that if a connection at a first priority local computing device fails, a connection is attempted at second priority local computing device, a third priority local computing device, and so on. Conventional user interfaces do not allow for the assignment of such a priority for either sorting or failover purposes.

5) Alienation of prior customers: One concern faced by software developers while improving software is the risk of alienating prior customers if the user interface is changed too drastically. For instance, a prior user or customer of a connection manager may have invested significant amounts of time learning shortcuts, hotkeys, writing program code or batch execution files, or the user may simply prefer the existing interface. If an interface is changed too rapidly, these users may be alienated, and decide to forego upgrading if significant learning will be required, and decide instead to use a competitor's product. This concern could be abated if the user is given the option to select which user interface to use, at runtime.

Accordingly, it is desirable to provide an improved user interface to overcome the drawbacks associated with conventional user interfaces. Additionally, it is desirable to provide a user interface which addresses the cited deficiencies of user interfaces which relate to the management of a connection between a remote computing device and a local computing device.

### SUMMARY OF THE INVENTION

It is an object of the invention to address disadvantages found in conventional user interfaces, particularly with regard to those disadvantages which relate to the management of connections between a remote computing device and a local computing device.

In one aspect of the present invention, a connection between a local computing device and a remote computing device is managed using an improved user interface, by displaying an improved user interface, and displaying at least a first connection icon on the user interface, where the first connection icon represents a first connection between the remote computing device and a first local computing device. A user selection is input, where if the user selection includes the first connection icon, the first connection represented by the first connection icon becomes modifiable to alter the first connection, and where if the user selection selects an active area of the improved user interface, a second connection icon is displayed. The second connection icon represents a second connection different than the first connection, between the remote computing device and a second local computing device.

In more detail, a user can add a new connection by selecting an active area on the desktop, and a new connection dialog will appear to allow a user to easily add a new connection. If the user wishes to edit a particular connection, the user can select the connection icon and the connection configuration dialog will appear, allowing the user to edit or delete the existing connection. Connections can be added, edited or deleted unilaterally at the remote computing device, regardless of whether the remote computing device and the local computing device are currently exercising the connection.

The improved user interface addresses evolving customer needs for an interface which is more intuitive and/or standardized with conventional user interfaces. The improved user interface of the present invention is compatible with the user interface used by the Microsoft® Windows® family of operating systems, but the improved user interface provides for additional features designed around the management of a connection between a remote computing device and a local computing device. By addressing these additional features, the existing user base can be exposed to new ways of managing network connections and be easily migrated to an improved user interface which looks and feels like an interface with which they may be already familiar.

According to a preferred aspect of the invention, at least a first application icon is displayed, where the first application icon represents an application available for execution on the first local computing device.

By displaying published applications on the desktop, the improved user interface provides the user with a logical display of local and remote applications, so that a user can seamlessly execute all available programs without regard to the physical location of the application.

According to an additional preferred aspect of the invention, a keystroke management window is displayed, where the keystroke management window is user modifiable to accept a local keystroke management setting. If the local keystroke management setting is enabled, a keystroke is processed at the remote computing device, and if the local keystroke management setting is disabled, the keystroke is processed at the first local computing device.

By enabling the processing of keystrokes at a local computing device, the user can use hotkeys both remotely and locally to take advantage of time-saving shortcuts which were previously unavailable to users of thin client devices. For example, by configuring a remote computing device to ignore hotkeys remotely and transmit the hotkeys for processing at a local computer device, a user of the remote computing device can use the ALT-TAB hotkey to open multiple connections or applications executing at the local computing device or at multiple local computing devices, and switch between them with ease.

In another preferred aspect, the first connection icon and the second connection icon each include a priority, where the priority is a failover order.

Since standard user interfaces only allow icons to be sorted by name, date, type or size, the user interface of the present invention allows a user to assign a failover order, and sort icons accordingly. By assigning the priority property to an icon, a user is made aware of the failover order using the improved user interface.

In yet another preferred aspect, a desktop shell window is displayed, where the desktop shell window is user modifiable to accept a desktop shell setting. If the desktop shell setting is disabled, an alternate user interface is selected, and the improved user interface is disabled.

For users who may want to use an alternate user interface, such as a prior version, the desktop shell window allows a user to choose between interfaces. By allowing users to select a user interface that they may already be familiar with, these users may be less likely to feel alienated, and are more likely to continue using a product line with which they may have significant exposure.

The invention also contemplates an improved user interface which allows for the management of a connection between a remote computing device and a local computing device. Specifically, the improved user interface includes a connection management window, where the connection management window displays at least a first connection icon. The first connection icon represents a first connection between the remote computing device and a first local computing device. In the connection management window a user can either select the first connection icon or an active area within the connection management window. If the user selection includes the first connection icon, the first connection represented by the first connection icon becomes modifiable to alter the first connection, and if the user selection includes the active area, a new connection window appears and, upon designating a new connection, a second connection icon is displayed, where the second connection icon represents a second connection different from the first connection, between the remote computing device and a second local computing device.

According to a preferred aspect of the invention, the connection management window displays at least a first application icon, where the first application icon represents an application available for execution on the first local computing device.

In another preferred aspect of the invention, the improved user interface further includes a keystroke management window, where the keystroke management window is user modifiable to accept a local keystroke management setting. If the local keystroke management setting is enabled, a keystroke is processed at the remote computing device. If the local keystroke management setting is disabled, the keystroke is processed at the first local computing device.

In an additional preferred aspect of the invention, the first connection icon and the second connection icon each include a priority, and where the priority is a failover order.

In yet another preferred aspect of the invention, the improved user interface further includes a desktop shell window, where the desktop shell window is user modifiable to accept a desktop shell setting. If the desktop shell setting is disabled, an alternate user interface is selected and the improved user interface is disabled.

This brief summary has been provided so that the nature of the invention may be understood quickly. A more complete understanding of the invention can be obtained by reference to the following detailed description of the preferred embodiments thereof in connection with the attached drawings. It is to be understood that other embodiments may be utilized and changes may be made without departing from the scope of the present invention.

### BRIEF DESCRIPTION OF THE DRAWINGS

Referring now to the drawings in which like reference numbers represent corresponding parts throughout:

FIG. 1 depicts the exterior appearance of one embodiment of the invention;

FIG. 2 depicts an example of an internal architecture of the FIG. 1 embodiment;

FIG. 3 is a flow chart depicting the process for managing a connection between a remote computing device and a local computing device;

FIG. 4 depicts the management of a connection between a remote computing device and a local computing device using an example user interface according to the present invention, displaying the desktop shell window;

FIG. 5 depicts the management of a connection between a remote computing device and a local computing device using an example user interface according to the present invention, displaying the improved user interface;

FIG. 6 depicts the management of a connection between a remote computing device and a local computing device using an example user interface according to the present invention, displaying the keystroke management window; and

FIG. 7 depicts the management of a connection between a remote computing device and a local computing device using an example user interface according to the present invention, in a state where a connection between the remote computing device and a second local computing device is being added.

### DETAILED DESCRIPTION OF THE INVENTION

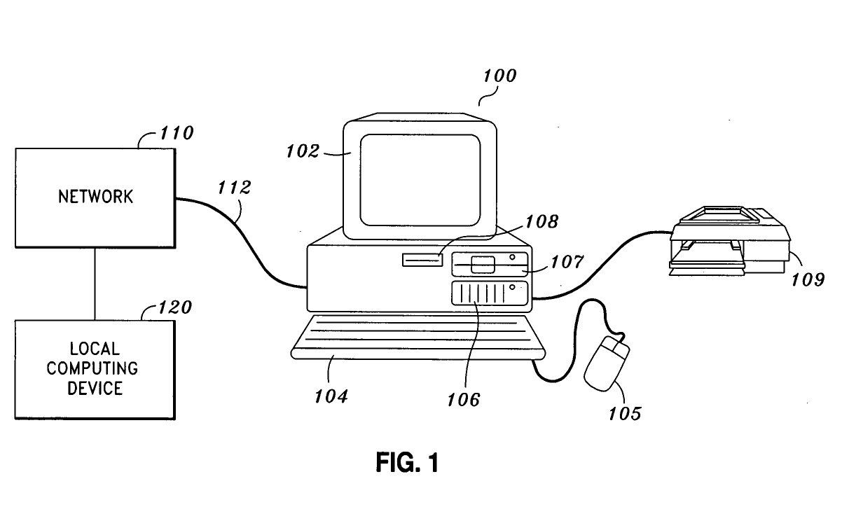

FIG. 1 is a view showing the exterior appearance of one embodiment of the invention. Computer 100 is a remote computing device, such as a thin client, where computer 100 includes computer-readable storage medium, such as fixed disk drive 106, for the management of a connection between a local computing device and a remote computing device using an improved user interface. As shown in FIG. 1, the hardware environment can include computer 100, display monitor 102 for displaying text and images to a user, keyboard 104 for entering text data and user commands into computer 100, mouse 105 for pointing, selecting and manipulating objects displayed on display monitor 102, fixed disk drive 106, removable disk drive 107, tape drive 108, hardcopy output device 109, computer network 110, computer network connection 112, and local computing device 120.

Computer 100 can be a desktop PC, a thin client, a laptop, a workstation, a midrange computer, a mainframe, a cash register, an automated teller machine (“ATM”), an industrial controller, a gateway, an internet protocol (“IP”) telephone, a server appliance, a personal digital assistant (“PDA”), or a cellular telephone without departing from the scope of the present invention. Display monitor 102 displays the graphics, images, and texts that comprise the user interface for the application of the present invention as well as the operating system programs necessary to operate the computer. An operator of computer 100 uses keyboard 104 to enter commands and data to operate and control the computer operating system programs as well as the application programs. The operator uses mouse 105 to select and manipulate graphics and text objects displayed on display monitor 102 as part of the interaction with and control of computer 100 and applications running on the computer. Mouse 105 can be any type of pointing device, including a joystick, a trackball, or a touch-pad without departing from the scope of the present invention.

The improved user interface for remote computing devices is stored locally on computer readable memory media such as fixed disk drive 106. Fixed disk drive 106 can comprise a number of physical drive units, such as a redundant array of independent disks (“RAID”) without departing from the scope of the present invention. Fixed disk drive 106 can also be a disk drive farm or a disk array that can be physically located in a separate computing unit without departing from the scope of the present invention. Such computer readable memory media allow computer 100 to access information such as user interface application data, computer-executable process steps, application programs and the like, stored on removable and non-removable memory media.

Network connection 112 can be a modem connection, a local-area network (“LAN”) connection including the Ethernet, and a broadband wide-area network (“WAN”) connection including digital subscriber line (“DSL”), Cable, T1, T3, Fiber Optics, and Satellite connection without departing from the scope of the present invention. Network 110 can be a LAN network, a corporate WAN network, or the Internet without departing from the scope of the present invention.

Removable disk drive 107 is a removable storage device that can be used to off-load data from computer 100 or upload data onto computer 100. Without departing from the scope of the present invention, removable disk drive 107 can be a floppy disk drive, an Iomega® Zip® drive, a compact disk-read only memory (“CD-ROM”) drive, a CD-Recordable drive (“CD-R”), a CD-Rewritable drive (“CD-RW”), a digital versatile disk-read only memory (“DVD-ROM”) drive, flash memory, a Universal Serial Bus (USB) flash drive, pen drive, key drive, or any one of the various recordable or rewritable DVD drives such as the DVD−R, DVD−RW, DVD-RAM, DVD+R, or DVD+RW. Operating system programs, applications, and various data files are stored on disks. The files can be stored on fixed disk drive 106 or on a removable media for removable disk drive 107 without departing from the scope of the present invention.

Tape drive 108 is a tape storage device that can be used to off-load data from computer 100 or upload data onto computer 100. Tape drive 108 can be quarter-inch cartridge (“QIC”), 4 mm digital audio tape (“DAT”), or 8 mm digital linear tape (“DLT”) drive without departing from the scope of the present invention.

Hardcopy output device 109 provides an output function for the operating system programs and applications including the improved user interface for remote computing devices. Hardcopy output device 109 can be a printer or any output device that produces tangible output objects, without departing from the scope of the present invention. While hardcopy output device 109 is shown as being directly connected to computer 100, it need not be. Hardcopy output device 109 may be connected via a network (e.g., wired or wireless network, not shown), for example.

While the improved user interface for remote computing devices runs on computer 100, which is used as a remote computing device such as a thin client, data is sent to computer 100 via network 110 and network connection 112, from local computing device 120. Local computing device 120 is a desktop PC, a laptop, a workstation, a midrange computer, a mainframe, a personal computer, a cash register, an ATM, an industrial controller, a gateway, an IP telephone, a server appliance, a thin client, a PDA, or a cellular telephone. Moreover, local computing device 120 can comprise multiple local computing devices without departing from the scope of the present invention.

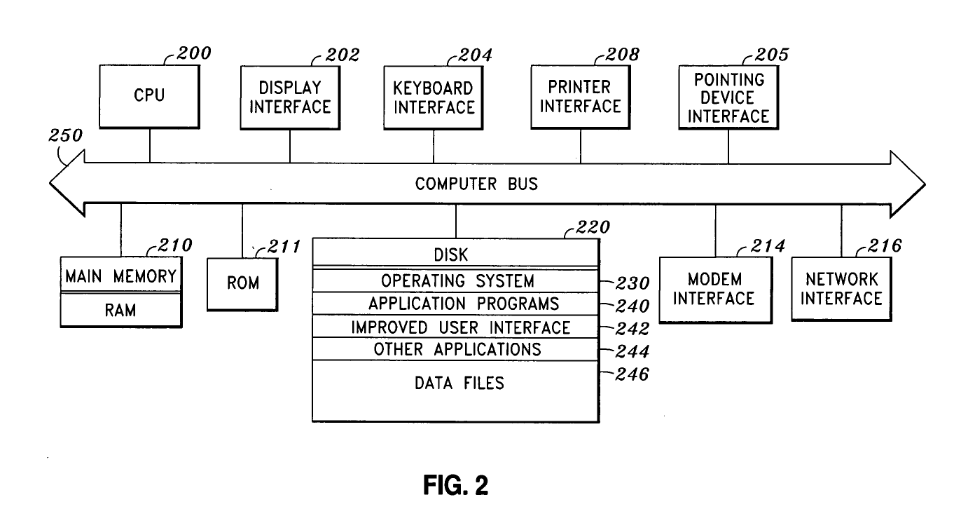

FIG. 2 is a detailed block diagram showing the internal architecture of computer 100. As shown in FIG. 2, the computing environment can include: central processing unit (“CPU”) 200 where the computer instructions that comprise an operating system or an application, including the improved user interface, are processed; display interface 202 which provides communication interface and processing functions for rendering graphics, images, and texts on display monitor 102; keyboard interface 204 which provides a communication interface to keyboard 104; pointing device interface 205 which provides a communication interface to mouse 105 or an equivalent pointing device; printer interface 209 which provides a communication interface to hardcopy output device 109; random access memory (“RAM”) 210 where computer instructions and data can be stored in a volatile memory device for processing by CPU 200; read-only memory (“ROM”) 211 where invariant low-level systems code or data for basic system functions such as basic input and output (I/O), startup, or reception of keystrokes from keyboard 104 are stored in a non-volatile memory device; disk 220 which can comprise fixed disk drive 106 and removable disk drive 107, where the files that comprise operating system 230, application programs 240 (including improved user interface 242 and other applications 244) and data files 246 are stored; modem interface 214 which provides a communication interface to computer network 116 over a modem connection; and computer network interface 216 which provides a communication interface to computer network 116 over a computer network connection. The constituent devices and CPU 200 communicate with each other over computer bus 250.

RAM 210 interfaces with computer bus 250 so as to provide quick RAM storage to CPU 200 during execution of software programs such as the operating system application programs, and device drivers. More specifically, CPU 200 loads computer-executable process steps from fixed disk drive 106 or other memory media into a field of RAM 210 in order to execute software programs. Data, including data relating to the improved user interface, can be stored in RAM 210, where the data can be accessed by CPU 200 during execution.

Also shown in FIG. 2, disk 220 stores computer-executable code for a windowing operating system 230, application programs 240 such as word processing, spreadsheet, presentation, graphics, image processing, gaming, etc. applications. Disk 220 also stores the improved user interface for remote computing devices 242. The management of connections between a local computing device and a remote computer using an improved user interface is preferably implemented as shown, however it is also possible to implement the improved user interface for remote computing devices according to the invention as a dynamic link library (“DLL”), or as a plug-in to other application programs such as an Internet web-browser such as the Microsoft® Internet Explorer® web browser.

CPU 200 can be any of the high-performance CPUs, including an Intel CPU, a PowerPC CPU, a MIPS RISC CPU, a SPARC CPU, a Alpha CPU or a proprietary CPU for a mainframe, without departing from the scope of the present invention. CPU 200 in computer 100 can comprise more than one processing units, including a multiple CPU configuration found in high-performance workstations and server, or a multiple scalable processing units found in mainframes.

Operating system 230 can be: Windows® CE/NT/2000/XP Workstation; Windows® NT/2000/XP Server; a variety of Unix-flavor operating systems, including AIX for IBM workstations and servers, SunOS for Sun workstations and servers, Linux for Intel CPU-based workstations and servers, HP-UX for HP workstations and servers, Irix for SGI workstations and servers, VAX/VMS for DEC computers, OpenVMS for Alpha-based computers, Mac OS X for PowerPC based workstations and servers; or a proprietary operating system for mainframe computers.

FIGS. 1 and 2 illustrate a preferred embodiment of a computing system that executes program code, or program or process steps, configured to manage a connection between a remote computing device and a local computing device using an improved user interface. Other types of computing systems may also be used as well.

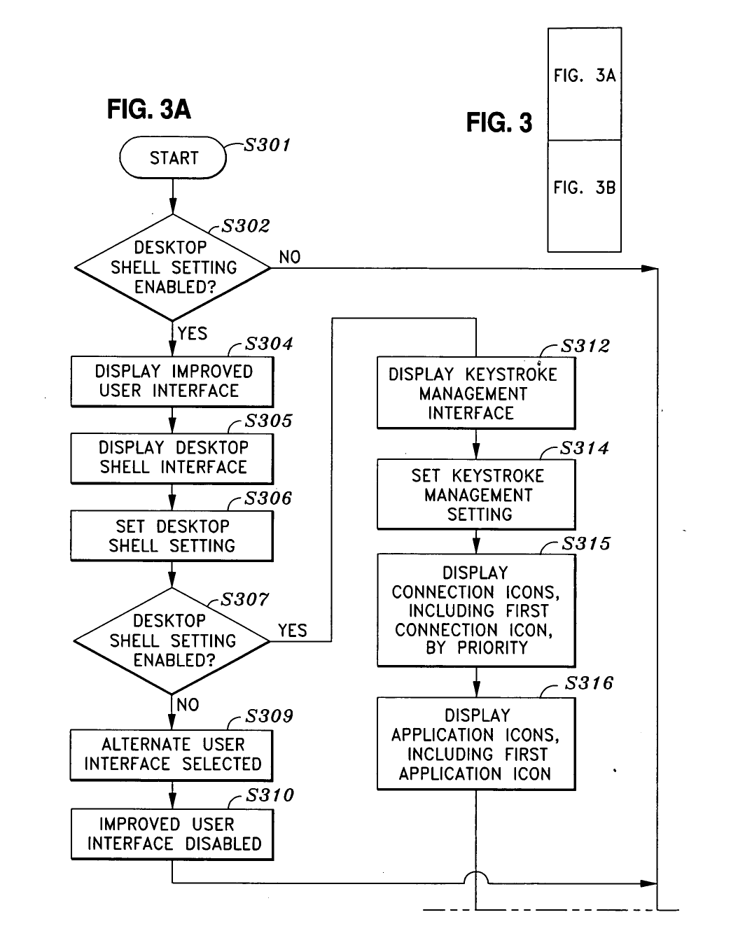

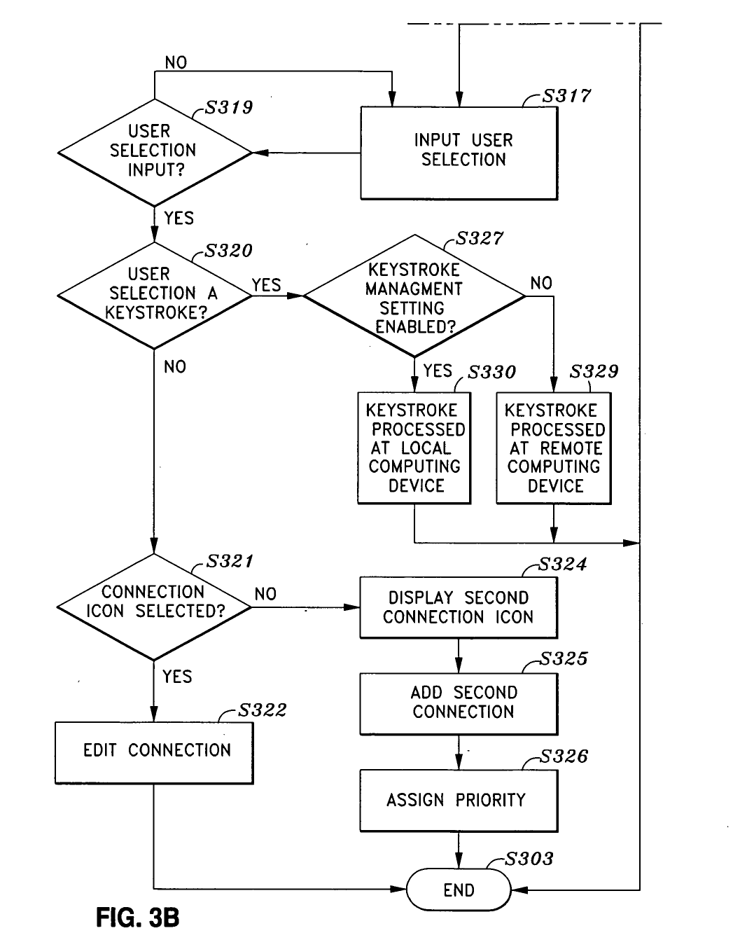

FIG. 3 illustrate a flowchart depicting the process used by the improved user interface for remote computing, in accordance with the present invention. FIGS. 4 to 7 are exemplary views of the improved user interface according to the invention.

Briefly, according to FIG. 3, an improved user interface is displayed, and at least a first connection icon is displayed on the user interface, where the first connection icon represents a first connection between the remote computing device and a first local computing device. A user selection is input, where if the user selection includes the first connection icon, the connection represented by the first connection icon becomes modifiable to alter the first connection. If the user selection includes an active area of the improved user interface, a second connection icon is displayed. The second connection icon represents a second connection different from the first connection, between the remote computing device and a second local computing device.

In more detail, upon starting (step S301), a check is performed to detect whether the desktop shell setting is enabled (step S302). A typical registry such as a Windows® registry has one main entry for the desktop shell, such as “(Launch41=Explorer.exe).” To facilitate use of the improved user interface, a second registry entry is inserted, such as “(Launch

40=WBTShell.exe).” When the desktop shell setting is selected (see infra, step S306), a registry entry is set so that when the remote computing device reboots, all registry values under the appropriate registry key are executed.

Each user interface can be modified to exit if the registry key is incorrect, so that all user interfaces are executed and the non-selected user interfaces exit. Using this technique, it is possible for a user to select one of several user interfaces.

If the desktop shell setting is not enabled, the improved user interface for remote computing devices is not displayed, and processing ends (step S303). If the desktop shell setting is enabled, the improved user interface for remote computing devices is displayed (step S304). The improved user interface includes a connection management window, where the connection management window is user modifiable to accept a user selection.

As illustrated in FIG. 4, improved user interface 400 launches connection management window 401 for managing a connection between computer 100 and local computing device 120. Connection management window includes desktop 402.

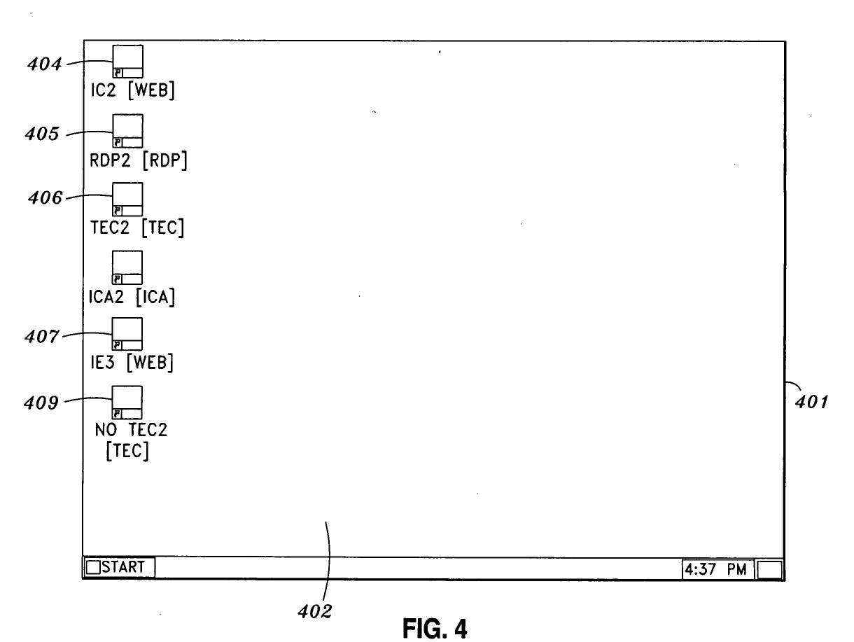

The desktop shell window is displayed (FIG. 3, step S305). The desktop shell window is user modifiable to accept a desktop shell setting. Specifically, as depicted in FIG. 5, improved user interface 400 launches desktop shell window 501. Desktop shell window 501 includes controls such as radio button 502 and radio button 504. Controls on desktop shell window 501 allow the user to select one of a plurality of user interfaces, by selecting the control which is associated with the desired user interface. Desktop shell window 501 may have a default user interface selected, so that if the user does not make a selection, a user interface will be automatically selected.

The feature of a desktop shell window is beneficial for users who may want to use an alternate user interface, such as a prior version of the improved user interface. In this regard, the desktop shell window allows a user to choose between several interfaces at run-time, giving users the flexibility to choose the most efficient user interface. By allowing users to select a user interface that they may already be familiar with, these users may be more apt to upgrade to newer versions of a user interface, such as the improved user interface, and will be less likely to feel alienated if changes to an interface are overwhelming.

As the Microsoft® Windows® family of operating systems continue to gain popularity, users of remote client devices demand user interfaces which are more PC-like in order to reduce the amount of training required to switch from a fat client device. Additionally, since customers may be accustomed to using conventional user interfaces, the desktop shell window gives the customer flexibility to choose which is the most efficient user interface for themselves.

As such, newer interfaces such as the improved user interface can be modified so that they are more intuitive and/or standardized with existing conventional user interfaces, such as those user interfaces user by the Microsoft® Windows® family of operating systems. In this regard, the improved user interface allows for additional features and functionalities which specifically relate to the management of a connection between a remote computing device and a local computing device. By addressing these features, an existing user base is exposed to new ways of managing connections between computing devices, and can be easily migrated to an improved user interface which appears and operates like a user interface with which the user may already be familiar.

The desktop shell setting is set, using the desktop shell window (FIG. 3, step S306). Specifically, a user selects a control, such as radio button 502 or radio button 504, depending on their user interface preference, and presses a second control, such as button 505, to accept this selection. As stated above, the desktop shell setting may be set by default or may be automatically set without active user interaction.

When the desktop shell setting is selected, the appropriate registry entry is set, such that registry values associated with the selected registry key are executed when the remote computing device reboots. Alternatively, each user interface can be modified so that if their associated registry key is not selected, all non-selected under interfaces exit, so that the user can select from more than two user interfaces.

Once the desktop shell setting is set, a check is performed to detect whether the desktop shell setting is enabled (FIG. 3, step S307). This check is performed by detecting which control the user has selected on desktop shell window 501. If the user selects radio button 502, the desktop shell setting is disabled, and if the user selects radio button 504, the desktop shell setting is enabled.

If the desktop shell setting is disabled (in step S306), an alternate user interface is selected (step S309). Specifically, a registry entry is set which selects the alternate user interface, so that when the remote computing device reboots, all registry values relating to the alternate user interface are executed. The improved user interface for remote computing devices is disabled (step S310), and processing ends (step S303).

If the desktop shell setting is enabled (in step S306), a keystroke management window is displayed (step S312), where the keystroke management window is user modifiable to accept a local keystroke management setting.

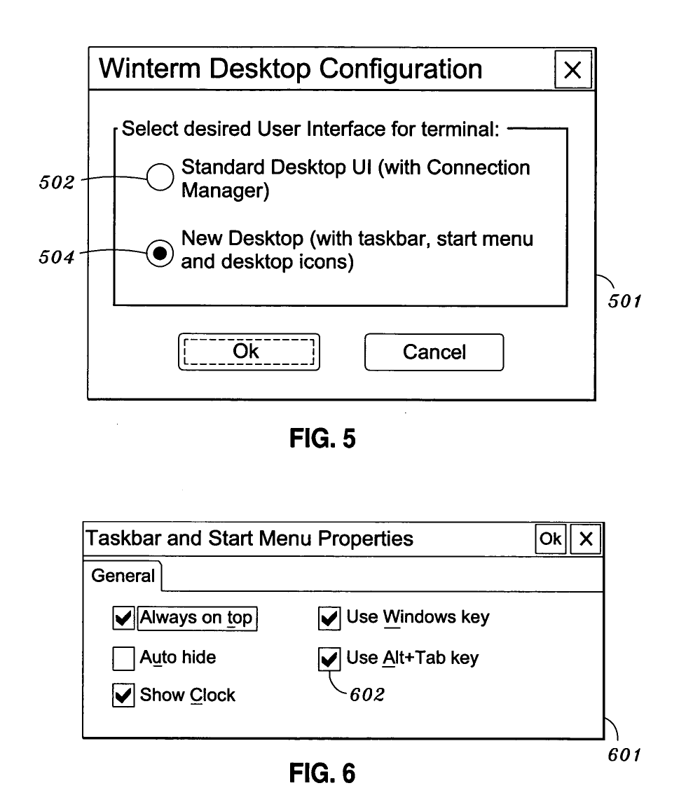

Specifically, as illustrated in FIG. 6, improved user interface 400 launches keystroke management window 601. Keystroke management window 601 includes controls, such as checkbox 602, which allow a user to set a keystroke management setting. The keystroke management setting allows a user to enable or disable processing of hotkey keystrokes at the local computing device.

By enabling the processing of keystrokes at a local computing device, the user can use hotkey keystrokes either remotely and locally, to take advantage of time-saving shortcuts which were previously unavailable to users of thin client devices. For example, and as shown in FIG. 6, by configuring a remote computing device to ignore hotkeys remotely and transmit the hotkeys for processing at a local computer device, a user of a remote computing device can use the ALT-TAB hotkey to open multiple connections or applications on the local computing device, and switch between them with ease.

The keystroke management setting is set, using the keystroke management window (step S314). The keystroke management setting is set by selecting or deselecting a control such as check box 601 on keystroke management window 601. By allowing a user to customize how they want keystrokes to be interpreted, users are given increased flexibility to choose the user interface which is best for them.

The connection management window displays at least one connection icon, including a first connection icon, where the first connection icon represents a first connection between the remote computing device and a first local computing device (step S315).

illustrated in FIG. 4, connection management window 401 displays first connection icon 404 and second connection icon 405 on desktop 402, where first connection icon 404 represents a first connection between computer 100 and local computing device 120.

The first connection icon and the second connection icon each include a priority, where the priority is a failover order. Failover order is a feature of thin clients where if one connection to a server fails, then it will attempt to connect to the next connection in the failover order.

Since standard user interfaces only allow icons to be sorted by name, date, type or size, the user interface of the present invention allows a user to assign a failover order, and sort icons accordingly. By assigning the priority property to an icon, a user be made aware of the order in which connections will attempt to connect using the improved user interface.

In an additional aspect of the present invention, the priority is not a failover order.

The connection management window displays at least a first application icon, where the first application icon represents an application available for execution on the first local computing device (FIG. 3, step S316).

Specifically, improved user interface 401 displays first application icon 407 and second application icon 408, where first application icon 407 represents a published application on local computing device 120.

By displaying published applications on the desktop, the improved user interface provides the user with an intelligent display of local and remote applications, so that a user can seamlessly execute all available programs without regard to where the application is physically stored. The new sorting features and automatic display of published applications also provide a more logical display than conventional user interfaces.

When the remote computing device connects to the local computing device, all of the published applications from the local computing device are automatically displayed on the improved user interface. At login, a software agent parses the managed connection, and creates shortcuts on the improved user interface for each published application associated with the connection. Upon logging off or rebooting, these shortcut files are deleted from the improved user interface, so that no application icons remain from a previous session.

The connection management window inputs a user selection (FIG. 3, step S317). The user selection is input using an input device, such as keyboard 104 or mouse 105. A check is performed to determine whether a user selection has been input (step S319). If a user selection has not been input, the connection management awaits the input of the user selection (step S317). If a user selection has been input, a check is performed to detect whether the user selection includes a hotkey keystroke (step S320).

“Hotkey” keystrokes are keyboard shortcuts to cursor or mouse movements. For instance, one popular hotkey keystroke is the ALT-TAB hotkey, which allows a user to easily switch between multiple executing applications using the keyboard, instead of clicking on controls on the user interface with a mouse. In conventional user interfaces, the remote computing device will intercept a hotkey keystroke, and execute the associated function remotely, instead of transmitting the keystroke through the connection.

If the user selection does not include a hotkey keystroke, a check is performed to detect whether the user selection includes first connection icon 404 or an active area on the desktop (step S321).

The user selection includes first connection icon 404 if the user points the cursor in the area over first connection icon 404, and then selects first connection icon 404 by clicking a button on mouse 105. The user selection includes an active area if the user points the cursor on an empty area of desktop 402, where desktop 402 is not displaying first connection 404, and clicks a button on mouse 105.

If the user selection includes the first connection icon, the first connection which is represented by the first connection icon becomes modifiable to alter the first connection (step S322), and processing ends (step S303).

When a connection is edited, properties relating to the connection are changed, or the connection is deleted altogether. If the user wishes to edit a particular connection, the user can select the connection icon, and the connection configuration dialog (not shown) will appear, allowing the user to edit or delete the existing connection.

FIG. 4 illustrates the improved user interface in a state where second connection icon 405 has already been added. Second connection icon 405 was added by selecting an active area of desktop 402. Since the user selection included an active area, a new connection window appears and, upon designating a new connection, second connection icon 405 was displayed. Second connection icon 405 represents a second connection different from the first connection, between the remote computing device and a second local computing device (step S324).

After second connection icon 405 is displayed, the connection which is represented by second connection icon 405 is added (step S325), a priority is assigned to second connection icon 405 (step S326), and processing ends (step S303).

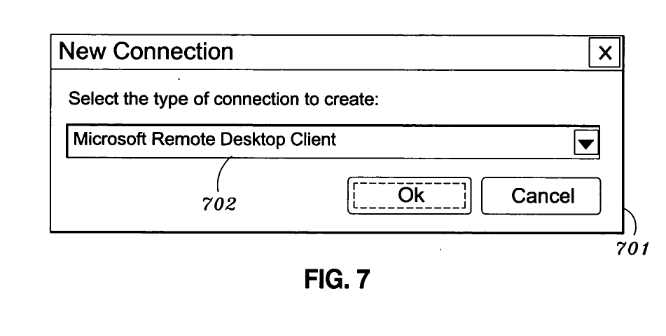

To add the connection, improved user interface 401 launches new connection interface 701, illustrated in FIG. 7. New connection interface 701 includes controls such as drop down list 702 which allow a user to configure a new connection.

Connections, including the connections represented by first connection icon 404 and second connection icon 405, can be added, edited or deleted at the remote computing device, as long as the remote computing device and the local computing device are not currently communicating on the connection. As such, the user has the ability to add or configure a connection to a local computing device prior to the transmission of data.

If, at step S320, the user selection includes a hotkey keystroke, a check is performed to determine whether the keystroke management setting is enabled (step S327).

If the keystroke management setting is disabled, the hotkey keystroke is processed at the remote computing device (step S329), and processing ends (step S303). In this regard, the hotkey keystroke is processed on the remote computing device as normal.

If the keystroke management setting is enabled, the hotkey keystroke is processed at a local computing device (step S330), and processing ends (step S303). Specifically, the improved user interface is instructed to ignore the hotkey keystroke, and therefore the keystroke is transmitted through the active connection for processing by the local computing device.

Although the improved user interface for remote computing devices has been described in accordance with the preferred processing method, above, certain processing steps may be omitted in additional aspects of the invention.

According to one aspect, for instance, the present invention provides for an improved user interface for managing a connection between a local computing device and a remote computing device, in which an improved user interface is displayed (step S305), and at least a first connection icon is displayed on the user interface (step S315), where the first connection icon represents a first connection between the remote computing device and a first local computing device. Additionally, a user selection is input (step S319), where if the user selection includes the first connection icon (step S321), the first connection represented by the first connection icon becomes modifiable to alter the first connection (step S322). If the user selection includes an active area of the improved user interface (step S321), a second connection icon is displayed (step S324), where the second connection icon represents a second connection different from the first connection, between the remote computing device and a second local computing device (step S325). According to this aspect, the remaining steps, as described above in the third aspect, are omitted.

According to a second aspect, the present invention provides for an improved user interface for managing a connection between a local computing device and a remote computing device, in which an improved user interface is displayed (step S305), and at least a first connection icon is displayed on the user interface (step S315), where the first connection icon represents a first connection between the remote computing device and a first local computing device. Additionally, a user selection is input (step S319), where if the user selection includes the first connection icon (step S321), the first connection represented by the first connection icon becomes modifiable to alter the first connection (step S322). If the user selection includes an active area of the improved user interface (step S321), a second connection icon is displayed (step S324), where the second connection icon represents a second connection different from the first connection, between the remote computing device and a second local computing device (step S325). At least a first application icon is displayed (step S316), where the first application icon represents an application available for execution on the first local computing device. According to this aspect, the remaining steps, as described above in the preferred aspect, are omitted.

According to a third aspect, the present invention provides for an improved user interface for managing a connection between a local computing device and a remote computing device, in which an improved user interface is displayed (step S305), and at least a first connection icon is displayed on the user interface (step S315), where the first connection icon represents a first connection between the remote computing device and a first local computing device. Additionally, a user selection is input (step S319), where if the user selection includes the first connection icon (step S321), the first connection represented by the first connection icon becomes modifiable to alter the first connection (step S322). If the user selection includes an active area of the improved user interface (step S321), a second connection icon is displayed (step S324), where the second connection icon represents a second connection different from the first connection, between the remote computing device and a second local computing device (step S325). A keystroke management window is displayed (step S312), where the keystroke management window is user modifiable to accept a local keystroke management setting (step S314). If the local keystroke management setting is enabled (step S327), a keystroke is processed at the remote computing device (step S329). If the local keystroke management setting is disabled (step S327), the keystroke is processed at the first local computing device (step S330). According to the third aspect, the remaining steps, as described in the preferred aspect, are omitted.

According to a fourth aspect, the present invention provides for an improved user interface for managing a connection between a local computing device and a remote computing device, in which an improved user interface is displayed (step S305), and at least a first connection icon is displayed on the user interface (step S315), where the first connection icon represents a first connection between the remote computing device and a first local computing device. Additionally, a user selection is input (step S319), where if the user selection includes the first connection icon (step S321), the first connection represented by the first connection icon becomes modifiable to alter the first connection (step S322). If the user selection includes an active area of the improved user interface (step S321), a second connection icon is displayed (step S324), where the second connection icon represents a second connection different from the first connection, between the remote computing device and a second local computing device (step S325). The first connection icon and the second connection icon each include a priority (step S315, step S326). According to this aspect, the remaining steps, as described above, are omitted.

According to a fifth aspect, the present invention provides for an improved user interface for managing a connection between a local computing device and a remote computing device, in which an improved user interface is displayed (step S305), and at least a first connection icon is displayed on the user interface (step S315), where the first connection icon represents a first connection between the remote computing device and a first local computing device. Additionally, a user selection is input (step S319), where if the user selection includes the first connection icon (step S321), the first connection represented by the first connection icon becomes modifiable to alter the first connection (step S322). If the user selection includes an active area of the improved user interface (step S321), a second connection icon is displayed (step S324), where the second connection icon represents a second connection different from the first connection, between the remote computing device and a second local computing device (step S325). A desktop shell window is displayed (step S305), where the desktop shell window is user modifiable to accept a desktop shell setting (step S306). If the shell setting is disabled, an alternate user interface is selected (step S309), and the improved user interface is disabled (step S310). According to this aspect, the remaining steps, as described above, are omitted.

Although the improved user interface has been illustrated as a sequence of windows in a windowing operating system, the improved user interface can be configured in a variety of other ways. For example, the user interface could be configured as a one-page design, or as a pattern of tiled windows.

The invention has been described with particular illustrative embodiments. It is to be understood that the invention is not limited to the above-described embodiments and that various changes and modifications may be made by those of ordinary skill in the art without departing from the spirit and scope of the invention.

1. An improved user interface for managing a connection between a remote computing device and a local computing device, comprising:
a connection management window displaying at least a first connection icon, the first connection icon representing a first connection between the remote computing device and a first local computing device,
wherein in the connection management window a user can either select the first connection icon or an active area within the connection management window,
wherein if the user selection includes the first connection icon, the connection represented by the first connection icon becomes modifiable to alter the first connection, and
wherein if the user selection includes the active area, a new connection window appears and, upon designating a new connection, a second connection icon is displayed, wherein the second connection icon represents a second connection different from the first connection, between the remote computing device and a second local computing device.

2. An improved user interface for managing a connection between a remote computing device and a local computing device according to claim 1, wherein the connection management window displays at least a first application icon, wherein the first application icon represents an application available for execution on the first local computing device.

3. An improved user interface for managing a connection between a remote computing device and a local computing device according to claim 1, further comprising a keystroke management window, wherein the keystroke management window is user modifiable to accept a local keystroke management setting,
wherein if the local keystroke management setting is enabled, a keystroke is processed at the remote computing device, and
wherein if the local keystroke management setting is disabled, the keystroke is processed at the first local computing device.

4. An improved user interface for managing a connection between a remote computing device and a local computing device according to claim 1, wherein the first connection icon and the second connection icon each include a priority.

5 An improved user interface for managing a connection between a remote computing device and a local computing device according to claim 1, wherein the priority is a failover order.

6. An improved user interface for managing a connection between a remote computing device and a local computing device according to claim 1, further comprising a desktop shell window, wherein the desktop shell window is user modifiable to accept a desktop shell setting,
wherein if the desktop shell setting is disabled, an alternate user interface is selected and the improved user interface is disabled.

7. A method for managing a connection between a local computing device and a remote computing device using an improved user interface, comprising the steps of:
displaying an improved user interface;
displaying at least a first connection icon on the user interface, the first connection icon representing a first connection between the remote computing device and a first local computing device;
inputting a user selection, wherein if the user selection includes the first connection icon, the connection represented by the first connection icon becomes modifiable to alter the first connection, and wherein if the user selection includes an active area of the improved user interface, a second connection icon is displayed, wherein the second connection icon represents a second connection different than the first connection, between the remote computing device and a second local computing device.

8. A method for managing a connection between a local computing device and a remote computing device using an improved user interface according to claim 7, further comprising the step of displaying at least a first application icon, wherein the first application icon represents an application available for execution on the first local computing device.

9 A method for managing a connection between a local computing device and a remote computing device using an improved user interface according to claim 7, further comprising the step of displaying a keystroke management window, wherein the keystroke management window is user modifiable to accept a local keystroke management setting,
wherein if the local keystroke management setting is enabled, a keystroke is processed at the remote computing device, and
wherein if the local keystroke management setting is disabled, the keystroke is processed at the first local computing device.

10. A method for managing a connection between a local computing device and a remote computing device using an improved user interface according to claim 7, wherein the first connection icon and the second connection icon each include a priority.

11. A method for managing a connection between a local computing device and a remote computing device using an improved user interface according to claim 7, wherein the priority is a failover order.

12. A method for managing a connection between a local computing device and a remote computing device using an improved user interface according to claim 7, further comprising the steps of:
displaying a desktop shell window, wherein the desktop shell window is user modifiable to accept a desktop shell setting;
selecting an alternate user interface, if the desktop shell setting is disabled;
disabling the improved user interface, if the desktop shell setting is disabled.

13. A computer-readable storage medium in which is stored a program for managing a session, said program comprising codes for managing a connection between a local computing device and a remote computing device using an improved user interface, said program comprising codes for permitting the computer to perform:
a first displaying step for displaying an improved user interface;
a second displaying step for displaying at least a first connection icon on the user interface, the first connection icon representing a first connection between the remote computing device and a first local computing device;
an inputting step for inputting a user selection, wherein if the user selection includes the first connection icon, the connection represented by the first connection icon becomes modifiable to alter the first connection, and wherein if the user selection includes an active area of the improved user interface, a second connection icon is displayed, wherein the second connection icon represents a second connection different than the first connection, between the remote computing device and a second local computing device.

14. A computer-readable storage medium in which is stored a program for managing a session according to claim 13, said program comprising codes for managing a connection between a local computing device and a remote computing device using an improved user interface, said program comprising codes for permitting the computer to perform:
a third displaying step for displaying at least a first application icon, wherein the first application icon represents an application available for execution on the first local computing device.

15 A computer-readable storage medium in which is stored a program for managing a session according to claim 13, said program comprising codes for managing a connection between a local computing device and a remote computing device using an improved user interface, said program comprising codes for permitting the computer to perform:
a fourth displaying step for displaying a keystroke management window, wherein the keystroke management window is user modifiable to accept a local keystroke management setting,
wherein if the local keystroke management setting is enabled, a keystroke is processed at the remote computing device, and
wherein if the local keystroke management setting is disabled, the keystroke is processed at the first local computing device.

16. A computer-readable storage medium in which is stored a program for managing a session according to claim 13, said program comprising codes for managing a connection between a local computing device and a remote computing device using an improved user interface, said program comprising codes for permitting the computer to perform:
a fifth displaying step for displaying a desktop shell window, wherein the desktop shell window is user modifiable to accept a desktop shell setting;
a selecting step for selecting an alternate user interface, if the desktop shell setting is disabled;
a disabling step for disabling the improved user interface, if the desktop shell setting is disabled.

17. Computer-executable program code stored on a computer readable medium, said computer-executable program code for use managing a connection between a local computing device and a remote computing device using an improved user interface, the computer-executable program code comprising:
code for displaying an improved user interface;
code for displaying at least a first connection icon on the user interface, the first connection icon representing a first connection between the remote computing device and a first local computing device;
code for inputting a user selection, wherein if the user selection includes the first connection icon, the connection represented by the first connection icon becomes modifiable to alter the first connection, and wherein if the user selection includes an active area of the improved user interface, a second connection icon is displayed, wherein the second connection icon represents a second connection different than the first connection, between the remote computing device and a second local computing device.

18. Computer-executable program code stored on a computer readable medium according to claim 17, said computer-executable program code for use managing a connection between a local computing device and a remote computing device using an improved user interface, the computer-executable program code comprising:
code displaying at least a first application icon, wherein the first application icon represents an application available for execution on the first local computing device.

19 Computer-executable program code stored on a computer readable medium according to claim 17, said computer-executable program code for use managing a connection between a local computing device and a remote computing device using an improved user interface, the computer-executable program code comprising:
code for displaying a keystroke management window, wherein the keystroke management window is user modifiable to accept a local keystroke management setting,
wherein if the local keystroke management setting is enabled, a keystroke is processed at the remote computing device, and
wherein if the local keystroke management setting is disabled, the keystroke is processed at the first local computing device.

20. Computer-executable program code stored on a computer readable medium according to claim 17, said computer-executable program code for use managing a connection between a local computing device and a remote computing device using an improved user interface, the computer-executable program code comprising:
code for displaying a desktop shell window, wherein the desktop shell window is user modifiable to accept a desktop shell setting;
code for selecting an alternate user interface, if the desktop shell setting is disabled; and
code for disabling the improved user interface, if the desktop shell setting is disabled.

21. A programmed computer apparatus for managing a connection between a local computing device and a remote computing device using an improved user interface, said programmed computer apparatus comprising:
means for displaying an improved user interface;
means for displaying at least a first connection icon on the user interface, the first connection icon representing a first connection between the remote computing device and a first local computing device;
means for inputting a user selection, wherein if the user selection includes the first connection icon, the connection represented by the first connection icon becomes modifiable to alter the first connection, and wherein if the user selection includes an active area of the improved user interface, a second connection icon is displayed, wherein the second connection icon represents a second connection different than the first connection, between the remote computing device and a second local computing device.

22. A programmed computer apparatus for managing a connection between a local computing device and a remote computing device using an improved user interface according to claim 21, said programmed computer apparatus comprising:
means for displaying at least a first application icon, wherein the first application icon represents an application available for execution on the first local computing device.

23 A programmed computer apparatus for managing a connection between a local computing device and a remote computing device using an improved user interface according to claim 21, said programmed computer apparatus comprising:
means for displaying a keystroke management window, wherein the keystroke management window is user modifiable to accept a local keystroke management setting,
wherein if the local keystroke management setting is enabled, a keystroke is processed at the remote computing device, and
wherein if the local keystroke management setting is disabled, the keystroke is processed at the first local computing device.

24. A programmed computer apparatus for managing a connection between a local computing device and a remote computing device using an improved user interface according to claim 21, said programmed computer apparatus comprising:
means for displaying a desktop shell window, wherein the desktop shell window is user modifiable to accept a desktop shell setting;
means for selecting an alternate user interface, if the desktop shell setting is disabled;
means for disabling the improved user interface, if the desktop shell setting is disabled.
